(19) United States
(12) Patent Application Publication
(10) Pub. No.: US 2006/0238573 A1
(43) Pub. Date: Oct. 26, 2006

(54) Monolithic fluid ejection device and method for fabricating the same

(75) Inventors: Hung Sheng Hu, Kaohsiung (TW); Wei Lin Chen, Taipei (TW); Der Rong Shyn, Shinzu County (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/410,654

(22) Filed: Apr. 25, 2006

(30) Foreign Application Priority Data
Apr. 25, 2005 (TW) 94113075

(51) Int. Cl. H04R 17/00

(52) U.S. Cl. 347/54; 29/25.35; 29/890.01; 310/328; 347/65

(57) ABSTRACT

A method for fabricating a monolithic fluid ejection device. The method includes providing a substrate with a signal transmitting circuit and a heating element. A protective layer is formed to cover the signal transmitting circuit and a heating element. A first patterned resistive layer is formed to define a predetermined sacrificial layer area. A sacrificial layer is formed on the predetermined sacrificial layer area. After removing the first resistive layer, a second patterned resistive layer is formed to define a predetermined structural layer area. After forming a structural layer, the second resistive layer is removed. A manifold is formed by etching from the back of the substrate to expose the sacrificial layer. Finally, a chamber is formed by removing the sacrificial layer.

### BACKGROUND OF THE INVENTION

1. Field of the Invention

The invention relates to a method for fabricating a fluid ejection device, and in particular to a method for fabricating an improved monolithic fluid ejection device.

2. Description of the Related Art

Typically, fluid injectors are employed in inkjet printers, fuel injectors, biomedical chips and other devices. Among inkjet printers presently known and used, injection by thermally driven bubbles has been most successful due to its reliability, simplicity and relatively low cost.

FIG. 1 is a cross section of a conventional monolithic fluid injector 1 disclosed in U.S. Pat. No. 6,102,530, the entirety of which is hereby incorporated by reference. A structural layer 12 is formed on a silicon substrate 10. A fluid chamber 14 is formed between the silicon substrate 10 and the structural layer 12 to receive fluid 26. A first heater 20 and a second heater 22 are disposed on the structural layer 12. The first heater 20 generates a first bubble 30 in the chamber 14, and the second heater 22 generates a second bubble 32 in the chamber 14 to inject the fluid 26 from the chamber 14. The conventional monolithic fluid injector 1 using bubbles as a virtual valve is advantageous due to reliability, high performance, high nozzle density and low heat loss. As inkjet chambers are integrated in a monolithic silicon wafer and arranged in a tight array to provide high device spatial resolution, no additional nozzle plate is needed.

The ink passage of the conventional monolithic fluid injector 1 is formed by anisotropic etching, and the chamber 14 is formed by etching a sacrificial layer such as silicon oxide through anisotropic etching. The silicon oxide, however, must be formed at high process temperature and removed by etching with hydrofluoric acid, thereby narrowing the process windows thereof. Furthermore, since the structural layer 12 is made of silicon nitride, a part of the structural layer 12 would be removed simultaneously in the etching process of the sacrificial layer, reducing the thickness of the structural layer 12. The durability of the monolithic fluid injector is impaired with low thickness of the structural layer 12, resulting in reduced lifetime.

Therefore, a novel method for fabricating a monolithic fluid ejection device with a strengthened structural layer is desirable.

### BRIEF SUMMARY OF THE INVENTION

Monolithic fluid ejection devices are provided. An exemplary embodiment of a monolithic fluid ejection device comprises a substrate with a manifold passing therethrough; a heating element formed on the substrate; a signal transmitting circuit formed on the heating element, exposing a part of the top surface of the heating element; a protective layer covering the heating element and the signal transmitting circuit; an electroplating seed layer covering the protective layer; a structural layer with nozzles passing therethrough formed on the substrate, wherein the structural layer comprises a metal layer; and a chamber installed between the substrate and the structural layer, wherein the nozzles connect directly to the manifold via the chamber.

Another exemplary embodiment of a monolithic fluid ejection device comprises a substrate with a manifold passing therethrough; a heating element formed on the substrate; a signal transmitting circuit formed on the heating element, exposing a part of the top surface of the heating element; a protective layer covering the heating element and the signal transmitting circuit; a structural layer with nozzles passing therethrough formed on the substrate, wherein the structural layer is made of polymer; and a chamber installed between the substrate and the structural layer, wherein the nozzles connect directly to the manifold via the chamber.

Methods for fabricating the monolithic fluid ejection device are also provided. An exemplary embodiment of a method comprises the following steps: providing a substrate, having a first surface and a second surface on the opposite side of the first surface; forming a heating element and a signal transmitting circuit on the first surface of the substrate; forming a protective layer to cover the signal transmitting circuit and a heating element; forming an electroplating seed layer over the first surface; forming a first patterned resistive layer on the electroplating seed layer, wherein the uncovered electroplating seed layer is defined as a predetermined sacrificial layer area; forming a sacrificial layer on the predetermined sacrificial layer area; forming a second patterned resistive layer on the sacrificial layer and the electroplating seed layer to define a predetermined structural layer area after removing the first resistive layer; forming a structural layer on the predetermined structural layer area; removing the second patterned resistive layer to form nozzles passing through the structural layer; and forming a manifold by etching through the substrate from the second surface thereof, exposing the sacrificial layer; and forming a chamber by removing the sacrificial layer.

An other exemplary embodiment of a method for fabricating the monolithic fluid ejection device comprises the following steps: providing a substrate having a first surface and a second surface on the opposite side of the first surface; forming a heating element and a signal transmitting circuit on the first surface of the substrate; forming a protective layer to cover the signal transmitting circuit and a heating element; forming an electroplating seed layer over the first surface; forming a patterned resistive layer on the electroplating seed layer, wherein the uncovered electroplating seed layer is defined as a predetermined sacrificial layer area; forming a sacrificial layer on the predetermined sacrificial layer area; removing the resistive layer; forming a polymer structural layer covering the first surface; patterning the polymer structural layer to form nozzles passing through the polymer structural layer; forming a manifold by etching through the substrate from the second surface thereof, exposing the sacrificial layer and forming a chamber by removing the sacrificial layer.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a conventional monolithic fluid injection device

FIGS. 2a˜2j are cross sections of the process of manufacturing a monolithic fluid injection device according to a first embodiment of the invention; and;

FIGS. 3a˜3i are cross sections of the process of manufacturing a monolithic fluid injection device according to a second embodiment of the invention.

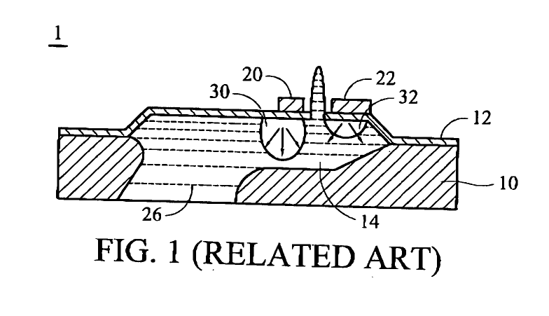

### DETAILED DESCRIPTION OF THE INVENTION

### FIRST EMBODIMENT

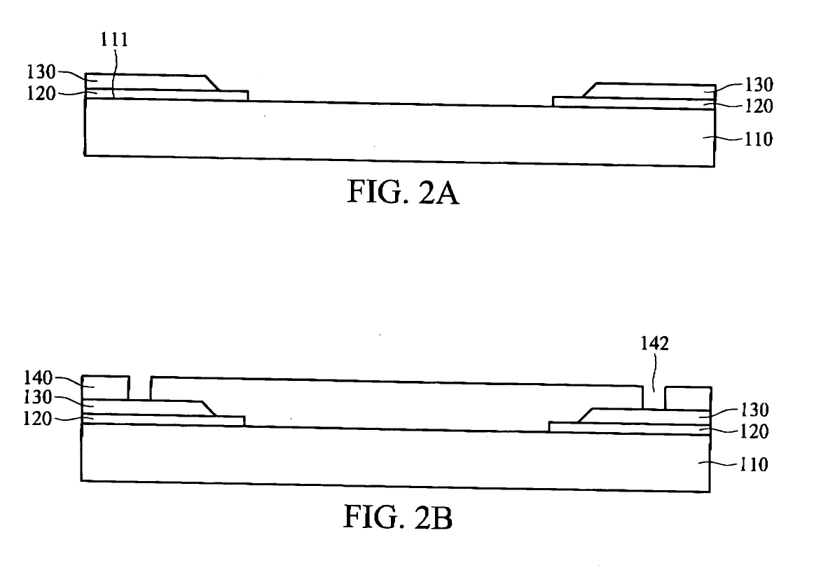

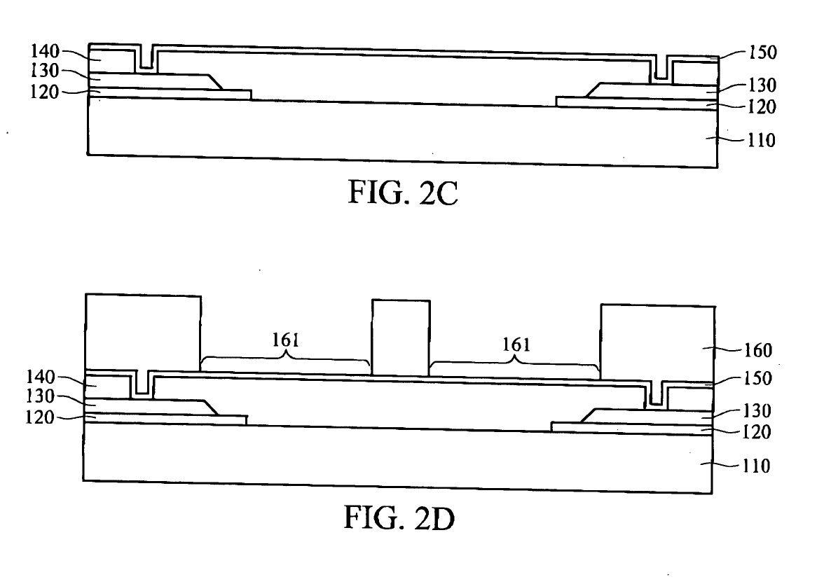

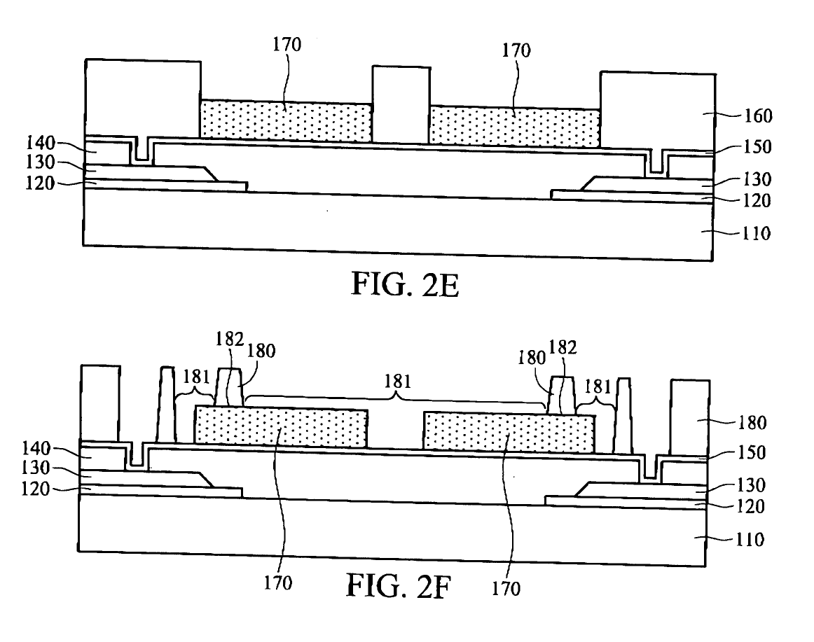

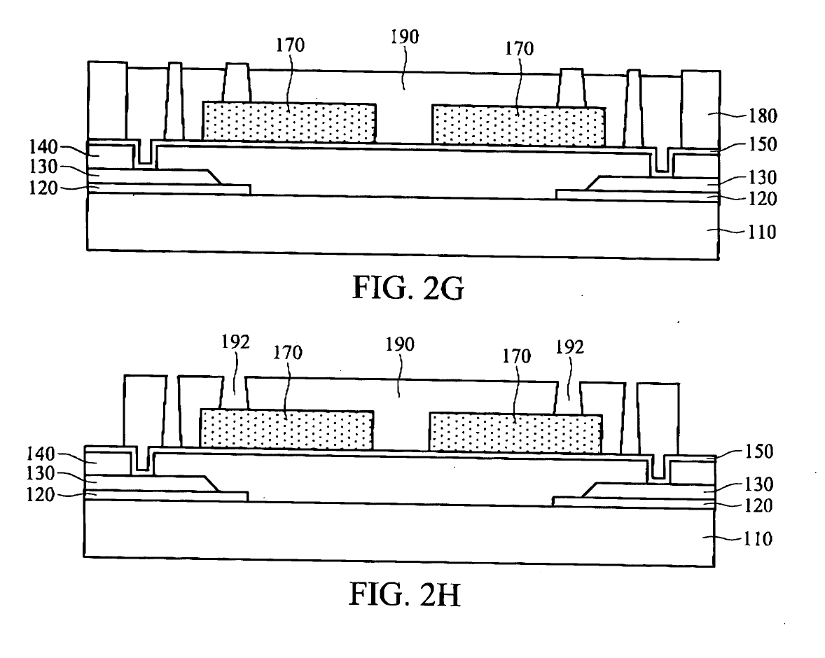

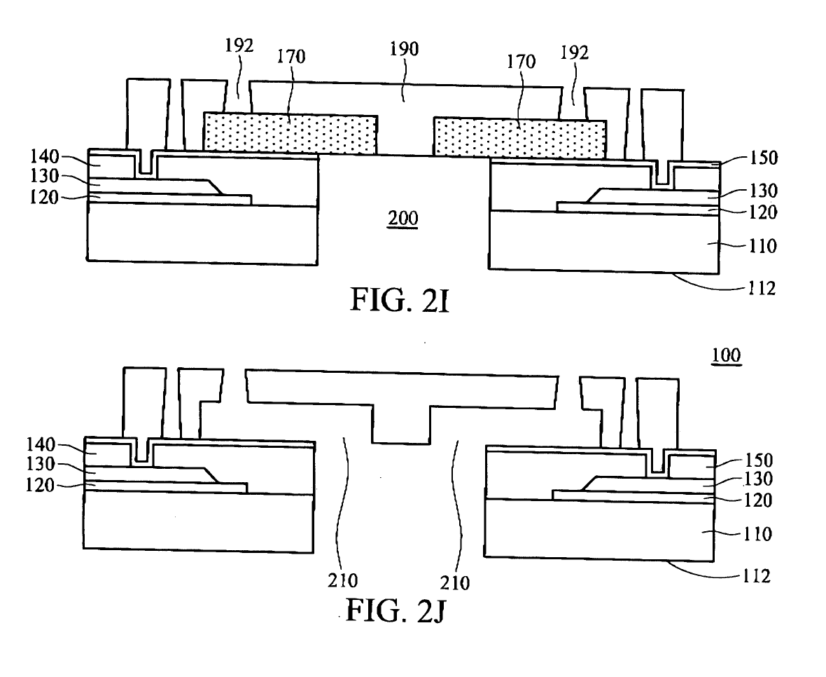

FIGS. 2a-2j are cross sections of the process of manufacturing a monolithic fluid injection device 100 according to a first embodiment of the invention.

First, referring to FIG. 2a, a resist layer and a conductive layer are sequentially formed on a first surface 111 of a substrate 110, and then patterned by a photolithography process. Next, the conductive layer is further patterned to form the signal transmitting circuit 130, exposing a part of the heating element 120. Herein, the materials for the heating element 120 and signal transmitting circuit 130 are unlimited, and can be the materials suitable to use in a monolithic fluid injection device. The resist layer can comprise HfB2, TaAl, or TaN. The conductive layer can comprise Al, Cu, or AlCu.

Next, referring to FIG. 2b, a protective layer 140 is blanketly formed on the first surface 111, covering the heating element 120 and signal transmitting circuit 130. Next, the protective layer 140 is etched to form an opening 142 passing through the protective layer 140, exposing the top surface of the signal transmitting circuit 130. Wherein, the protective layer 140 can be silicon oxide, silicon nitride, silicon carbide or combinations thereof.

Next, referring to FIG. 2c, an electroplating seed layer 150 is blanketly formed on the protective layer 140 and electrically connected to the signal transmitting circuit 130 via the opening 142. Suitable material for the electroplating seed layer 150 can be TiW • Au • Ta • TaN or combinations thereof.

Referring to FIG. 2d, a first patterned resistive layer 160 is formed on the electroplating seed layer 150, wherein the surface of electroplating seed layer 150 uncovered by the first patterned resistive layer 160 is defined as a predetermined sacrificial layer area 161.

Referring to FIG. 2e, a sacrificial layer 170 is formed on the predetermined sacrificial layer area 161 by electroplating. Wherein, the sacrificial layer 170 is electrically conductive and can be Cu • Ni • Al or combinations thereof.

Next, referring to FIG. 2f, after completely removing the first patterned resistive layer 160, a second patterned resistive layer 180 is formed on the sacrificial layer 170 and the electroplating seed layer 150 to define a predetermined structural layer area 181. It should be noted, the second patterned resistive layer 180 is formed within a predetermined nozzle area 182 on the sacrificial layer.

Next, referring to FIG. 2g, a structural layer 190 is formed on the predetermined structural layer area 181. In this step, since the second patterned resistive layer 180 is formed on the predetermined nozzle area 182, the structural layer 190 is not formed on the predetermined nozzle area 182. Further, the thickness of the second patterned resistive layer 180 formed on the sacrificial layer 170 is greater that that of the structural layer 190 formed on the sacrificial layer 170. The structural layer 190 can be Au, Ni, Co, Pd, Pt or combinations thereof and formed by electroplating. Furthermore, the sacrificial layer 170 can be a dielectric material such as silicon nitride. Moreover, the materials of the sacrificial layer 170 and the structural layer 190 must be different. For example, the structural layer 190 can not be Ni when the sacrificial layer 180 comprises Ni.

Next, referring to FIG. 2h, the second patterned resistive layer 180 is completely removed to form nozzles 192 passing through the structural layer 190, exposing the sacrificial layer 170. Next, referring to FIG. 2i, a manifold 200 is formed by etching through the substrate from a second surface 112 thereof, exposing the sacrificial layer 170, wherein the second surface 112 is disposed on the opposite side of the first surface 111. Specifically, the manifold 200 is formed by laser etching, dry etching or wet etching.

Finally, referring to FIG. 2j, the sacrificial layer 170 is completely removed to form a chamber, installed between the substrate 110 and the structural layer 190, wherein the nozzles 192 connect directly to the manifold 200 via the chamber 210.

### SECOND EMBODIMENT

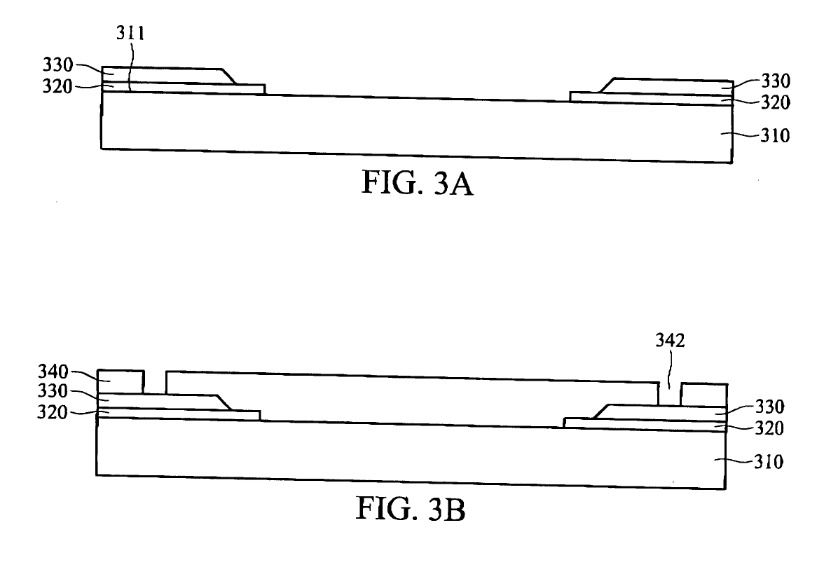

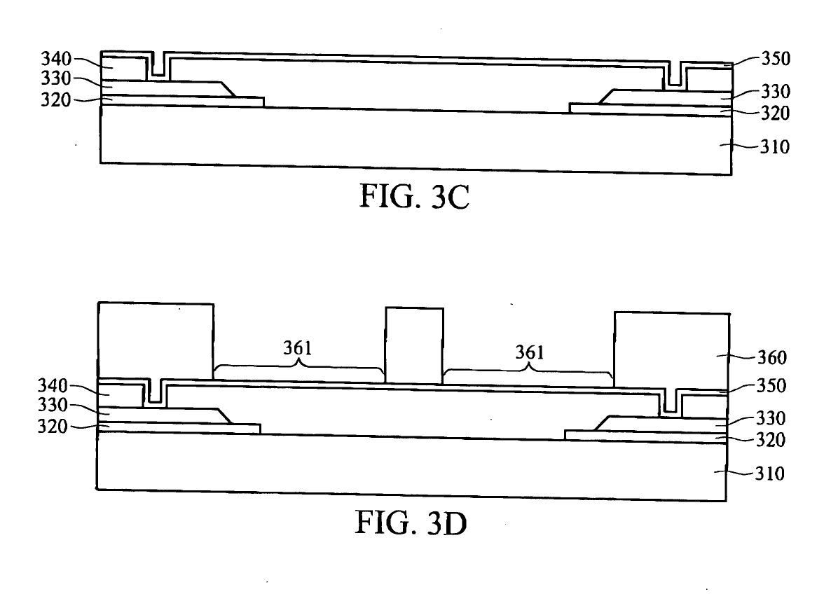

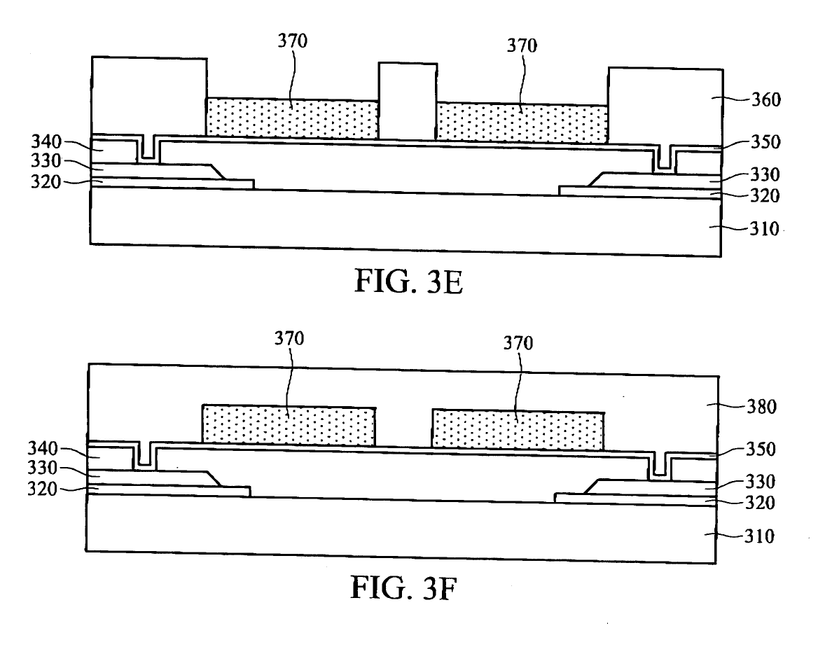

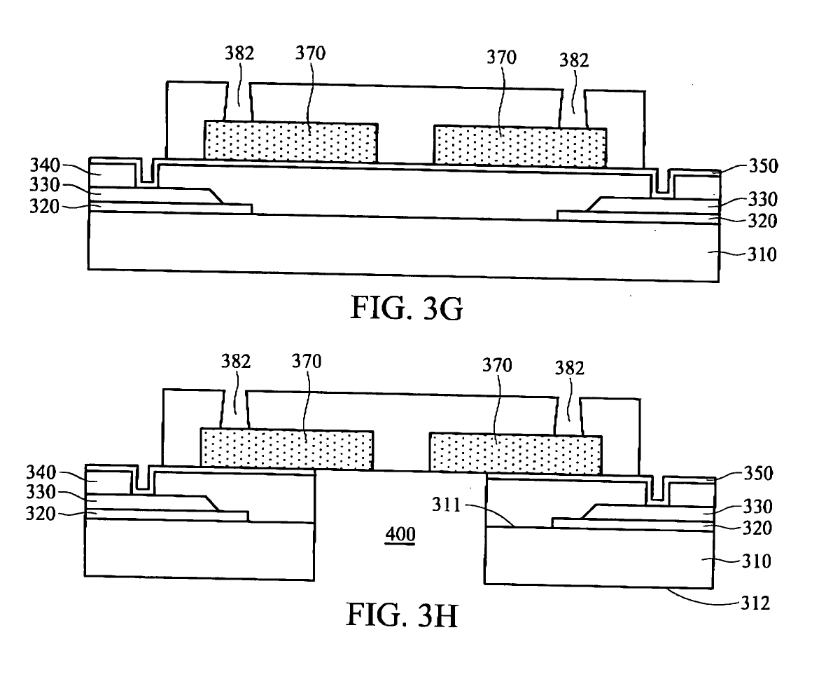

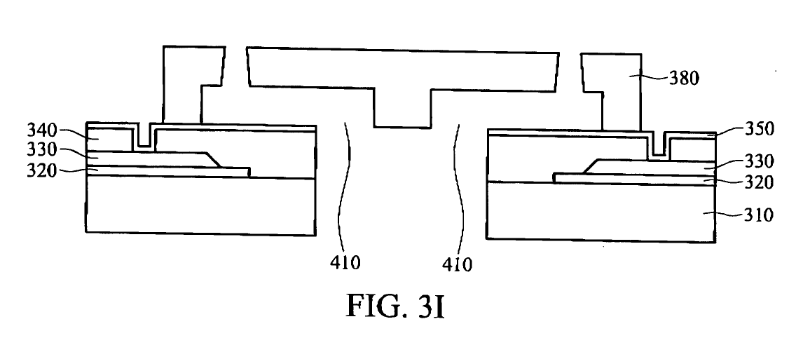

FIGS. 3a-3i are cross sections of the process of manufacturing a monolithic fluid injection device 300 according to a second embodiment of the invention.

First, referring to FIG. 3a, a resist layer and a conductive layer are sequentially formed on a first surface 311 of a substrate 310, and then patterned by a photolithography process. Next, the conductive layer is further patterned to form the signal transmitting circuit 330, exposing a part of the heating element 320. Herein, the materials for the heating element 320 and signal transmitting circuit 330 are unlimited, and can be the materials suitable to use in a monolithic fluid injection device. The resist layer can comprise HfB2, TaAl, or TaN. The conductive layer can comprise Al, Cu, or AlCu.

Next, referring to FIG. 3b, a protective layer 340 is blanketly formed on the first surface 311, covering the heating element 320 and signal transmitting circuit 330. Next, the protective layer 340 is etched to form an opening 342 passing through the protective layer 340, exposing the top surface of the signal transmitting circuit 330. Wherein, the protective layer 340 can be silicon oxide, silicon nitride, silicon carbide or combinations thereof.

Next, referring to FIG. 3c, an electroplating seed layer 350 is blanketly formed on the protective layer 340 and electrically connected to the signal transmitting circuit 130 via the opening 342. Suitable material for the electroplating seed layer 350 can be TiW • Au • Ta • TaN or combinations thereof.

Referring to FIG. 3d, a first patterned resistive layer 360 is formed on the electroplating seed layer 350, wherein the surface of electroplating seed layer 350 uncovered by the first patterned resistive layer 360 is defined as a predetermined sacrificial layer area 361.

Referring to FIG. 3e, a sacrificial layer 370 is formed on the predetermined sacrificial layer area 361 by electroplating, wherein, the sacrificial layer 370 is electrically conductive and can be Cu • Ni • Al or combinations thereof.

Next, referring to FIG. 3f, after completely removing the first patterned resistive layer 360, a polymer structural layer 380 is formed on the first surface 311 of the substrate 310, completely covering the sacrificial layer 370 and the electroplating seed layer 350. Herein, the polymer structural layer 380 can be a thick polymer film formed by spin coating or thermal lamination.

Next, referring to FIG. 3g, the polymer structural layer 380 is patterned to form nozzles 382 passing therethrough, exposing the surface of the sacrificial layer 370.

Next, referring to FIG. 3h, a manifold 400 is formed by etching through the substrate 310 from a second surface 312 thereof, exposing the sacrificial layer 370, wherein the second surface 312 is disposed on the opposite side of the first surface 311. Specifically, the manifold 400 is formed by laser etching, dry etching or wet etching

Finally, referring to FIG. 3i, the sacrificial layer 370 is completely removed to form a chamber, installed between the substrate 310 and the structural layer 380, wherein the nozzles 382 connect directly to the manifold 400 via the chamber 410.

Since the sacrificial layer is made of metal, the polymer structural layer is not damaged when removed from the sacrificial layer. Further, the manifold can be formed by etching the sacrificial layer through laser or dry etching. Accordingly, the invention provides methods for fabricating a monolithic fluid ejection device with improved stability, thereby increasing the lifetime thereof.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for fabricating a monolithic fluid ejection device, comprising:
providing a substrate having a first surface and a second surface on the opposite side of the first surface;
forming a heating element and a signal transmitting circuit on the first surface of the substrate;
forming a protective layer to cover the signal transmitting circuit and a heating element;
forming an electroplating seed layer over the first surface;
forming a first patterned resistive layer on the electroplating seed layer, wherein the uncovered electroplating seed layer is defined as a predetermined sacrificial layer area;
forming a sacrificial layer on the predetermined sacrificial layer area;
forming a second patterned resistive layer on the sacrificial layer and the electroplating seed layer to define a predetermined structural layer area after removing the first resistive layer;
forming a structural layer on the predetermined structural layer area;
removing the second patterned resistive layer to form nozzles passing through the structural layer;
forming a manifold by etching through the substrate from the second surface thereof, exposing the sacrificial layer; and
forming a chamber by removing the sacrificial layer.

2. The method as claimed in claim 1, wherein the process of forming the signal transmitting circuit and a heating element comprises:
sequentially forming a resist layer and a conductive layer on the first surface;
patterning the resist layer and the conductive layer to form the heating element; and
further patterning the conductive layer to form the signal transmitting circuit, exposing a part of the heating element.

3. The method as claimed in claim 1, wherein the signal transmitting circuit electrically contacts the heating element.

4. The method as claimed in claim 1, further comprising, after forming the protective layer:
forming an opening through the protective layer, exposing the signal transmitting circuit.

5. The method as claimed in claim 1, wherein the second patterned resistive layer is formed within a predetermined nozzle area over the sacrificial layer.

6. The method as claimed in claim 1, wherein the manifold is formed by laser etching.

7. The method as claimed in claim 1, wherein the manifold is formed by dry etching.

8. The method as claimed in claim 1, wherein the manifold is formed by wet etching.

9. The method as claimed in claim 1, wherein the sacrificial layer is removed by wet etching.

10. The method as claimed in claim 1, wherein the sacrificial layer is removed by wet etching.

11. The method as claimed in claim 1, wherein the protective layer comprises silicon nitride, silicon oxide, silicon carbide, or combinations thereof.

12. The method as claimed in claim 1, wherein the electroplating seed layer comprises TiW, Au, Ta, TaN or combinations thereof.

13. The method as claimed in claim 1, wherein the sacrificial layer comprises a metal layer.

14. The method as claimed in claim 1, wherein the sacrificial layer comprises Cu, Ni, Al, or combinations thereof.

15. A method for fabricating a monolithic fluid ejection device, comprising:
providing a substrate having a first surface and a second surface on the opposite side of the first surface;
forming a heating element and a signal transmitting circuit on the first surface of the substrate;
forming a protective layer to cover the signal transmitting circuit and a heating element;
forming an electroplating seed layer over the first surface;
forming a patterned resistive layer on the electroplating seed layer, wherein the uncovered electroplating seed layer is defined as a predetermined sacrificial layer area;
forming a sacrificial layer on the predetermined sacrificial layer area;
removing the resistive layer;
forming a polymer structural layer covering the first surface;
patterning the polymer structural layer to form nozzles passing through the polymer structural layer;
forming a manifold by etching through the substrate from the second surface thereof, exposing the sacrificial layer; and
forming a chamber by removing the sacrificial layer.

16. The method as claimed in claim 15, wherein the process of forming the signal transmitting circuit and the heating element comprises:
sequentially forming a resist layer and a conductive layer on the first surface;
patterning the resist layer and the conductive layer to form the heating element; and
further patterning the conductive layer to form the signal transmitting circuit, exposing a part of the heating element.

17. The method as claimed in claim 15, wherein the signal transmitting circuit electrically contacts the heating element.

18. The method as claimed in claim 15, further comprising, after forming the protective layer:
forming an opening through the protective layer, exposing the signal transmitting circuit.

19. The method as claimed in claim 15, wherein the nozzle is formed to pass through the polymer structural layer, exposing the sacrificial layer.

20. The method as claimed in claim 15, wherein the manifold is formed by laser etching.

21. The method as claimed in claim 15, wherein the manifold is formed by dry etching.

22. The method as claimed in claim 15, wherein the manifold is formed by wet etching.

23. The method as claimed in claim 15, wherein the sacrificial layer is removed by wet etching.

24. The method as claimed in claim 15, wherein the polymer structural layer comprises thick polymer film.

25. The method as claimed in claim 15, wherein the protective layer comprises silicon nitride, silicon oxide, silicon carbide, or combinations thereof.

26. The method as claimed in claim 15, wherein the electroplating seed layer comprises TiW, Au, Ta, TaN or combinations thereof.

27. The method as claimed in claim 15, wherein the sacrificial layer comprises a metal layer.

28. The method as claimed in claim 15, wherein the sacrificial layer comprises Cu, Ni, Al, or combinations thereof.

29. A monolithic fluid ejection device, comprising:
a substrate with a manifold passing therethrough;
a heating element formed on the substrate;
a signal transmitting circuit formed on the heating element, exposing a part of the top surface of the heating element;
a protective layer covering the heating element and the signal transmitting circuit;
an electroplating seed layer covering the protective layer;
a structural layer with nozzles passing therethrough formed on the substrate, wherein the structural layer comprises a metal layer; and
a chamber installed between the substrate and the structural layer, wherein the nozzles connect directly to the manifold via the chamber.

30. The device as claimed in claim 29, wherein the protective layer comprises silicon nitride, silicon oxide, silicon carbide, or combinations thereof.

31. The device as claimed in claim 29, wherein the electroplating seed layer comprises TiW, Au, Ta, TaN or combinations thereof.

32. The device as claimed in claim 29, wherein the structural layer comprises Au • Ni • Co • Pd • Pt or combinations thereof.

33. A monolithic fluid ejection device, comprising:
a substrate with a manifold passing therethrough;
a heating element formed on the substrate;
a signal transmitting circuit formed on the heating element, exposing a part of the top surface of the heating element;
a protective layer covering the heating element and the signal transmitting circuit;
a structural layer with nozzles passing therethrough formed on the substrate, wherein the structural layer is made of polymer; and
a chamber installed between the substrate and the structural layer, wherein the nozzles connect directly to the manifold via the chamber.

34. The device as claimed in claim 33, wherein the protective layer comprises silicon nitride, silicon oxide, silicon carbide, or combinations thereof.

35. The device as claimed in claim 33, wherein the structural layer comprises a thick polymer film.
